(19) United States
(12) Patent Application Publication
(10) Pub. No.: US 2017/0151900 A1
(43) Pub. Date: Jun. 1, 2017

(54) DEVICE FOR MANAGEMENT OF THE COLOR OF MOTOR VEHICLE LIGHTING

(71) Applicant: Valeo Vision, Bobigny Cedex (FR)

(72) Inventor: Pierre Albou, Paris (FR)

(21) Appl. No.: 15/359,786

(22) Filed: Nov. 23, 2016

(30) Foreign Application Priority Data
Nov. 26, 2015 (FR) 1561409

(51) Int. Cl. B60Q 1/00

(52) U.S. Cl. CPC B60Q 1/0076; B60Q 2400/20

(57) ABSTRACT

A device for controlling the color of polychromatic light produced by a conversion element adapted to convert a beam emitted by a monochromatic source into polychromatic light.

First sensing means and second sensing means are placed so as to intercept some of the polychromatic light re-emitted by the conversion element. The sensor means are respectively sensitive to the wavelength (λ1) of the beam emitted by the source and a second wavelength (λ2) different from the wavelength of the beam.

Calculation means are adapted to establish a relation (ρ) between signals (S1, S2) representing the amount of light received by the respective sensors and a control module supplies at least one instruction to the source and/or the conversion element to modify the operation thereof so as to modify the relation.

### CROSS-REFERENCE TO RELATED APPLICATIONS

This application claims priority to the French application 1561409, filed Nov. 26, 2015, which application is incorporated herein by reference and made a part hereof.

### BACKGROUND OF THE INVENTION

1. Field of the Invention

The present invention relates to the field of motor vehicle lighting and/or signaling and more particularly applies to adaptive lighting devices for such vehicles.

2. Description of the Related Art

Motor vehicles are commonly equipped with lighting modules intended both to light the road in driving situations in which the driver has reduced visibility (at night, during inclement weather, etc.) and to make the vehicle visible to other road users. Conventionally, a number of types of lighting coexist on a motor vehicle, including in particular so-called “high beam” lighting and so-called “low beam” lighting. So-called “high beam” lighting is produced by lighting modules that emit a beam directed toward the horizon and that light the whole of the road over the greatest possible distance, typically of the order of 200 meters with the light sources commonly used at present. So-called “low beam” lighting is produced by means of lighting modules that emit a beam inclined slightly downwards relative to the horizontal and delimited by an upper cut-off plane the object of which is to avoid dazzling other road users. So-called “low beam” lighting offers the driver a visibility of the order of a few tens of meters, typically 60 to 80 meters. This visibility, less than that offered by the “high beam” lighting, is sometimes insufficient for the driver.

To optimize the driver's view under all circumstances without penalizing other road users, adaptive front lighting systems (AFS) have been proposed. These adaptive front lighting systems are, for example, intended to detect the presence of a road user who may be dazzled by a “high beam” lighting beam and to modify the contour of that lighting beam to create a shadow area where the detected user is located. The driver of the vehicle therefore has a better view than is offered by “low beam” lighting, with greatly reduced dazzling of other users, and without intervention by the driver, whereas at present the change of mode between “high beam” and “low beam” lighting is manual, with all the risks of forgetting that this kind of manual change involves.

With adaptive front lighting functions of this kind, it is possible to employ high-power light sources making it possible to light the road over a long distance but with no risk of dazzling other road users. The light sources commonly used to produce long-range lighting beams include light-emitting diode (LED) sources. These sources make it possible to achieve high lighting powers for a low consumption of power and with a reduced overall size compared to incandescent sources.

A new development field concerns light sources employing laser diodes. Enabling a greater brightness to be obtained than light-emitting diodes for the same power; laser diodes also make it possible to produce more compact optics, which further increases the possibilities of integrating them into a motor vehicle light and the aesthetic possibilities for such a light and for such a vehicle.

The use of laser diodes of this kind involves a certain number of constraints, however. In fact, a laser diode emits a light beam that is monochromatic (i.e., at one wavelength) that is coherent (i.e., all the light waves emitted are in phase). The hazards for the eye of exposure to such radiation are known. For the use of such sources in the field of automotive lighting and/or signaling, it is therefore necessary to convert a beam of this kind into a beam of light that is not harmful to the eyes of persons who may be exposed to it. This involves in particular the conversion of the monochromatic beam into a polychromatic light beam, for example a beam of white light. To carry out this conversion, it is known to dispose between the monochromatic light source and the eye that will receive its radiation a material adapted to convert the directional monochromatic light beam emitted by the laser diode into an undirectional polychromatic beam. A material of this kind may notably contain phosphorescent materials, for example YAG doped with rare earths, to form wavelength conversion means.

It is important for it to be possible for the monochromatic light beam emitted by a laser source of this kind to be converted optimally into a polychromatic light beam and to this end the conversion efficiency of the element containing phosphorescent materials to which the light beam from the laser source is initially directed must be the optimum efficiency. Moreover, the safety of a system of this kind depends on the integrity of the conversion material, which the invention aims to preserve without switching off the device (which is dangerous in the case of a main lighting beam), at the same time as optimizing the optical efficiency of the system.

### SUMMARY OF THE INVENTION

An aim of the present invention is to propose a device for controlling the conversion of the monochromatic light beam emitted by one or more laser diodes into polychromatic light.

To this end, the invention consists in a device for controlling the color of polychromatic light, in which a light beam, emitted by a coherent monochromatic source, is directed toward a conversion element adapted to convert this directional monochromatic light beam into undirectional polychromatic light, and which includes at least first sensing means sensitive to the wavelength of the light beam emitted by the monochromatic source and adapted to supply a first signal representing the quantity of light that it has received at this first wavelength and second sensing means sensitive to a second wavelength, different from the first wavelength of the light beam emitted by the monochromatic source, and adapted to supply a second signal representing the quantity of light that it has received at this second wavelength.

The control device further includes calculation means for establishing a relation between the signals supplied by the first sensing means and by the second sensing means and a module for generating instructions to vary at least one parameter governing the characteristics of the converted polychromatic light to vary the relation established between the signals supplied by the first sensing means and by the second sensing means.

This module may notably include set point means calibrated beforehand to obtain one or more reference values of the relation established between the signals delivered by the first and second sensing means, means for comparing this relationship to predefined values in the set point means, adapted to generate a third signal representing the result of this comparison, and control means adapted to generate an instruction to the monochromatic source and/or the conversion element as a function of the value of the third signal. The set point means may notably include at least one set point value corresponding to a predefined optimum value of the relation established by the calculation means and a maximum value and a minimum value of that same relation that are acceptable.

The module according to the invention advantageously includes means for slaving the monochromatic source and/or the conversion element to a set point signal, notably to the third signal resulting from the comparison to a set of predefined set point values of the relation established on the basis of the signals respectively supplied by the first and second sensing means.

The comparison means may advantageously include means for normalizing the relation established by the calculation means.

The slaving means advantageously enable continuous modification in real time of the parameters of the monochromatic source and/or of the conversion element in order to maintain below a limit value the difference between the relation established on the basis of the signals respectively supplied by the first and second sensing means and a set point value of the relation.

The control means are advantageously adapted to slave the color emitted by the lighting device to a set point color, that is to say, if the emitted color drifts, to modify it, to move it toward the set point color, before it leaves a MacAdam ellipse of the set point color, or before it leaves limits imposed by regulations.

In fact, in order to comply with regulations and to ensure the comfort of a person observing the light beam emitted by the lighting device, it is important for the color of the light to remain close to a set point color. A color of this kind can in fact change because of the effect of some parameters such as, for example, the power supply of the monochromatic source, the optical saturation or temperature of the material adapted to convert the directional monochromatic light beam emitted by the laser diode into an undirected polychromatic beam.

According to features of the invention, the parameters that govern the characteristics of the converted radiation and on which the device according to the invention acts to vary the relation established between the signals supplied by the first and second sensing means can include parameters intrinsic to the monochromatic source and/or parameters intrinsic to the conversion element. By way of non-exhaustive examples, these parameters can include the temperature of the conversion element and/or the mean emission power of the monochromatic source: the monochromatic source can be modulated at a high frequency to display an image, in which case the mean power across the frame is controlled.

The first sensing means and the second sensing means may be placed in the vicinity of one another so as to intercept a portion of the undirectional polychromatic radiation converted by the conversion element. This ensures that the environmental conditions are substantially the same for each of the sensors and that the latter are thereafter not considered when establishing the ratio of the measurements from each of the sensors. The first sensor and the second sensor may notably be carried by the same support means or produced on the same semiconductor substrate.

The first sensor and/or the second sensor include a filter adapted to qualify the wavelength of the rays detected by the sensor(s). This therefore ensures that each sensor receives rays at wavelengths spread over a reduced range of values. In this context one of these two sensors may include a high-pass filter and the other an optionally complementary low-pass filter.

According to one preferred embodiment of the invention, the conversion element adapted to convert the monochromatic light beam into polychromatic light is produced from a phosphorescent and/or florescent material and broadly speaking takes the form of a plate. The luminophores used are chosen so that the converted polychromatic radiation contains, inter alia, the wavelength at which the monochromatic source emits.

The first sensing means are advantageously sensitive to a limited range of wavelengths situated around the wavelength of the source, notably to cover thermally induced drift in the wavelength thereof. The second sensing means are sensitive to a wavelength characteristic of the luminophores: for example green for the usual conversion materials.

According to one preferred, but non-exclusive, embodiment of the invention, the source emitting the monochromatic light beam is a laser diode emitting a beam at a wavelength in the blue region of the visible spectrum. The second sensor of the device according to the invention is then advantageously chosen to be essentially sensitive to a different wavelength: by way of non-exclusive example, there could be chosen a sensor essentially sensitive to a wavelength situated in the green region of the visible light spectrum.

According to variants of the invention, the first and second sensors could be on the same side of the conversion element as the monochromatic source or on its opposite side. In the former case, the conversion element could include a reflector element on its face opposite the face receiving the directional monochromatic light beam. This therefore ensures an optimum quantity of converted rays deflected in the direction of the sensors, whereas the phenomenon of conversion by the luminophores is of Lambertian type, that is to say that the converted rays exit the phosphor plate in all directions. The first and second sensors could be placed substantially in the specular reflection cone with regard to the conversion element and the angle of incidence of the directional monochromatic beam on it.

The invention also extends to a motor vehicle lighting and/or signaling lighting module that includes a device as described above for controlling the color of polychromatic light and in which the conversion element is placed in a focal plane of a device for forming a lighting and/or signaling light beam of the vehicle, for example a lens.

Other features, details and advantages of the invention will emerge more clearly from a reading of the description given hereinafter by way of example and with reference to FIG. 1, which is a diagrammatic view of a preferred embodiment of a device according to the invention applied to a lighting and/or signaling lighting module for a motor vehicle.

Hereinafter, “monochromatic source” refers to a system adapted to emit a monochromatic light beam. A system of this kind may consist of one or more laser diodes, but may equally include, in addition to such diodes, one or more intermediate beam-forming optics. It may also include one or more sets of mirrors onto which the beam or beams emitted by the laser diode or diodes is or are directed, as is the case in micro-electromechanical systems (MEMS) in which a coherent monochromatic beam emitted by one or more laser diodes is shifted, by moving one or more mirrors onto which it is directed, for example to implement adaptive front lighting functions. The generic term “monochromatic source” will be used hereinafter to refer to this type of light source, whether or not it includes elements other than one or more laser diodes.

These and other objects and advantages of the invention will be apparent from the following description, the accompanying drawings and the appended claims.

### BRIEF DESCRIPTION OF THE ACCOMPANYING DRAWINGS

FIG. 1 shows a preferred, but non-exclusive, embodiment of a device according to the invention in its application to the production of a lighting and/or signaling module for a motor vehicle.

### DETAILED DESCRIPTION OF THE PREFERRED EMBODIMENTS

Here a monochromatic light beam F is emitted by a coherent monochromatic light source 2. As indicated above, the monochromatic light source 2 includes at least one laser diode, but may also include, by way of non-exhaustive example, other elements such as a collimator, a set of mirrors, etc. According to one preferred, but non-exclusive, embodiment of the invention, a first wavelength λ1 of the light emitted by the monochromatic light source 2 is situated in the blue region of the visible spectrum.

The monochromatic light beam F is directed toward a wavelength conversion element 4 the function of which is to convert the directional monochromatic light beam F into polychromatic radiation in all directions in space. According to the invention, the wavelengths of the exit polychromatic radiation include a set of wavelengths different from the first wavelength λ1 at which the monochromatic light source 2 emits, it being understood that some of the excitation light may be diffused rather than converted. The wavelength conversion element 4 advantageously takes the form of a plate made from a phosphorescent material.

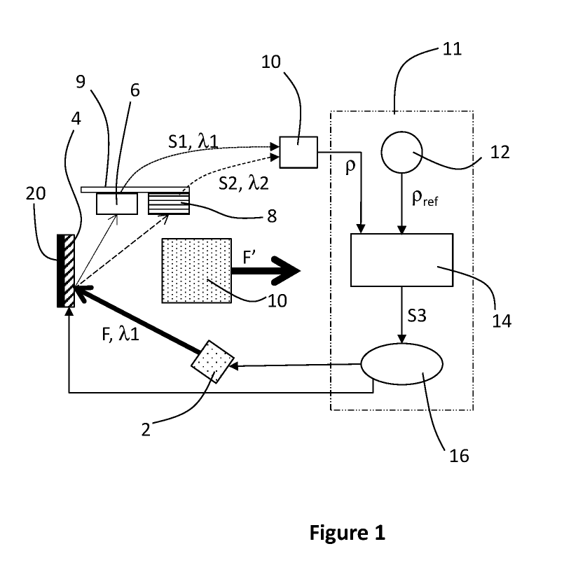

According to the embodiment illustrated by FIG. 1, the rear face of the plate constituting the wavelength conversion element 4, opposite the face that receives the monochromatic light beam F, is coated with a layer of a reflective material 20. The polychromatic radiation at the exit from the wavelength conversion element 4 is therefore oriented on the same side of the wavelength conversion element 4 as that on which the latter receives the monochromatic light beam F. A configuration of this kind makes it possible, in the event of failure of the wavelength conversion element 4, to prevent any transmission of all or part of the monochromatic light beam F through the wavelength conversion element and thus any possible damage to components situated behind that wavelength conversion element 4.

According to the invention, a first sensing means 6 and a second sensing means 8 including at least one respective sensing element are placed in the vicinity of one another in the undirectional polychromatic radiation re-emitted by the wavelength conversion element 4 so as to intercept a portion thereof. Their proximity enables the two sensing elements to be carried by the same support means 9. As will be explained hereinafter, it is particularly beneficial for the first and second sensing means 6, 8 to be subject to the same operating conditions within the lighting module (temperature, radiation, etc.).

According to the embodiment illustrated by FIG. 1, the first and second sensing means 6 and 8 are placed on the same side of the wavelength conversion element 4 as the monochromatic light source 2 emitting the monochromatic light beam F. According to this embodiment, the first and second sensing means 6 and 8 are advantageously placed substantially in the specular reflection cone of the plate constituting the wavelength conversion element 4.

According to the invention, the first sensing means 6 are chosen, on the one hand, to be sensitive to the first wavelength λ1 of the monochromatic light beam F and, on the other hand, to be able to deliver a first signal S1 representing the quantity of light that they detect at this first wavelength λ1. According to the invention, the second sensing means 8 are chosen, on the one hand, to be sensitive to a second wavelength λ2 of the converted polychromatic radiation different from the first wavelength λ1 of the monochromatic light beam F and, on the other hand, to be able to deliver a second signal S2 representing the quantity of light that they detect at this second wavelength λ2. The second wavelength λ2 to which the second sensing means 8 are sensitive is advantageously different from the first wavelength λ1 of the monochromatic light beam F but close to the latter. Accordingly, according to one preferred, but non-exclusive, embodiment of the invention, in which the first wavelength λ1 of the monochromatic light beam F is situated in the blue region of the visible spectrum, the second wavelength λ2 to which the second sensing means 8 are sensitive is chosen in the green region of the visible spectrum. Clearly a variation of the conversion efficiency of the wavelength conversion element 4 is reflected in a variation of the quantity of light converted, in particular, at the second wavelength λ2. According to the invention, these two variations are interlinked by a law determined so that the measurement of a variation of the quantity of light detected by the sensor means yields information on the state of deterioration of the wavelength conversion element 4.

At the practical level, the first and second sensing means 6 and 8 may each include at least one filter and an associated sensor element. The filter or filters is or are adapted to limit the range of wavelengths detectable by the associated sensor element. Clearly the choice of filter will be linked to the choice of wavelength to be measured. For example, in an embodiment of the invention in which the second wavelength λ2 to which the second sensing means 8 is sensitive is higher than the first wavelength λ1 of the monochromatic light beam F a low-pass filter may be disposed on the upstream side of the sensor element of the first sensing means 6 on the path of the reflected rays and re-emitted by the wavelength conversion element 4 and a high-pass filter may be disposed in a similar fashion on the upstream side of the sensor of the second sensing means 8. Also from a practical point of view, the first and second signals S1 and S2 delivered by the first and second sensing means 6 and 8, respectively, take the form of electric currents emitted by those sensors.

The device according to the invention also includes calculation means 10 adapted to establish a relation ρ between the first and second signals S1 and S2 delivered by the first and second sensing means 6 and 8, respectively. The calculation means 10 advantageously establish the ratio S1/S2 of the signal delivered by the first sensing means 6 to the signal delivered by the second sensing means 8. According to one preferred embodiment of the invention, the calculation means 10 include one or more components adapted to execute a rapid calculation, advantageously at a video timing rate. This makes it possible to process the first and second signals S1 and S2 delivered by the first and second sensing means 6 and 8 at very regular and closely spaced time intervals and therefore to determine the evolution thereof in real time.

An increase in the ratio S1/52 established between the signals delivered by the first and second sensing means 6 and 8 signifies that, in the polychromatic radiation re-emitted by the wavelength conversion element 4, the quantity of light present, at the first wavelength λ1, increases and/or the quantity of light present, at the second wavelength λ2, decreases. An increase in the ratio S1/S2 therefore represents a reduced efficiency of the conversion of the monochromatic light beam F into polychromatic radiation. This decrease in efficiency may be the result of various causes. In particular, it may be the result of causes specific to the monochromatic light source 2 or causes specific to the wavelength conversion element 4. For example, a decrease of this kind may be linked to a form of saturation of the wavelength conversion element 4 by the monochromatic light beam F: this is the case, for example, if the quantity of monochromatic light to be converted is too great for the quantity of material able to effect this conversion. A portion of the light of the monochromatic light beam F is then not converted into polychromatic radiation. The quantity of molecules, ions (in general, colored centers), excited within the wavelength conversion element 4 is no longer sufficient to react with all of the monochromatic light and the re-emitted light tends toward the original monochromatic color, here blue. Other causes of the decrease in the efficiency of the conversion of the monochromatic light beam F into polychromatic radiation may be linked to the wavelength conversion element 4 itself: in particular, it is known that the conversion efficiency of a material such as a phosphor decreases with temperature. Too high a temperature of the wavelength conversion element 4 can therefore rapidly degrade the conversion of the monochromatic light beam F. In the extreme situation in which the wavelength conversion element 4 became unable to effect the conversion of the monochromatic light beam F into polychromatic radiation, the quantity of light remitted by this wavelength conversion element 4 at the second wavelength λ2 would become zero and the ratio S1/S2 infinite. Conversely, if the monochromatic light source 2 is extinguished, the ratio S1/S2 becomes zero.

To optimize the efficiency of the wavelength conversion element 4, the invention proposes comparing the relation ρ, here the ratio S1/S2, established between the signals delivered by the first and second sensing means 6 and 8 to one or more reference values and then, based on the result of this comparison, to act on the monochromatic light source 2 and/or on the wavelength conversion element 4 itself so that this relation ρ remains within a predetermined difference relative to these reference values.

To this end, the device according to the invention includes a control module 11 which includes, in particular:

set point means 12, calibrated beforehand to obtain one or more reference values of the relation ρ established between the signals delivered by the first and second sensing means 6 and 8: by way of non-exhaustive example, an optimum value of the relation ρ, corresponding to an optimum efficiency of the wavelength conversion element 4, a maximum value and a minimum value of the relation ρ, defining the acceptable operating limits of the wavelength conversion element 4 with regard to the monochromatic light source 2,

comparison means 14 for comparing the relation ρ to the predefined values in the set point means 12, adapted to generate a third signal S3 representing the result of this comparison,

control means 16 adapted to act on the monochromatic light source 2 and/or on the wavelength conversion element 4 to modify its operation as a function of the value of the third signal S3 so as to modify the relation ρ.

In other words, the device according to the invention includes control means 16 for slaving the monochromatic light source 2 and/or the wavelength conversion element 4 to the third signal S3 resulting from the comparison of the relation ρ, established on the basis of the first and second signals S1 and S2 supplied by the first and second sensing means 6 and 8, respectively, to a set of predefined set point values. The comparison means 14 may advantageously include means for normalizing the relation ρ established by the calculation means 10.

These control means 16 make it possible in real time, that is to say at a sufficiently close timing rate to prevent any drift of the relation ρ, and continuously, that is to say progressively, to modify the parameters of the monochromatic light source 2 and/or of the wavelength conversion element 4 in order to maintain this relation ρ close to a set point value. By drift of the relation ρ is meant, for example, a drift such that the measured color of the light emitted by the lighting device exits the MacAdam ellipse centered on the color spot of the set point color. The MacAdam ellipse determines the area traced out in a chromatic diagram around the color point of a predetermined color such that a typical human observer does not distinguish any difference between any of the colors of the area within the predetermined color. Moreover, any drift of the relation ρ may lead to the color exiting limits imposed by regulations.

Thanks to these control means 16, it is therefore possible to maintain the emitted color relatively close to a set point color, that is to say, if it drifts, to modify it before it leaves the MacAdam ellipse of the set point color, in other words before a typical human observer can perceive a difference from this set point color or before it leaves limits imposed by regulations.

In other words, the control means 16 are adapted to slave the color emitted by the lighting device to a set point color, that it to say, if the emitted color drifts, to modify it, to move it toward the set point color, before it leaves the MacAdam ellipse of the set point color or before it leaves limits imposed by regulations.

To be more precise, the control means 16 may control the power of the monochromatic light source 2, for example to increase it or to decrease it. The control means 16 can therefore increase or decrease the quantity of light at the first wavelength λ1 received by the wavelength conversion element 4 from the monochromatic light source 2 and therefore, at constant efficiency of the wavelength conversion element 4, increase or decrease the quantity of light re-emitted by the latter, in particular at the second wavelength λ2.

If the monochromatic light source 2 includes a set of mirrors intended to deflect the monochromatic light beam F, for example, the control means 16 may act thereon to shift the monochromatic light beam F, for example at predefined time intervals, toward an opaque light absorption area that is adjacent the wavelength conversion element 4 and is not shown here. The quantity of light at the first wavelength λ1 that reaches the wavelength conversion element 4 can therefore be modified and thus, at constant efficiency of the wavelength conversion element 4, the quantity of light remitted by the latter modified, in particular at the second wavelength λ2. In this latter case, it is a modification of the emission temporal profile of the monochromatic light source 2 that will be reflected in a modification of the quantity of monochromatic light received and converted by the wavelength conversion element 4.

The control means 16 may also act on the wavelength conversion element 4 to modify its efficiency, at constant and predefined power emitted by the monochromatic light source 2. For example, the control means 16 may act on means for cooling the wavelength conversion element 4 (not represented in FIG. 1), since it is known that the efficiency thereof decreases if its temperature increases.

By a set of means that are simple and easy to use, the invention therefore makes it possible to control the color of the polychromatic radiation converted by a wavelength conversion element 4 from the monochromatic light beam F. Basing this control on the analysis of the relation ρ established between the signals delivered by the first sensing means 6 and by the second sensing means 8 sensitive to the first wavelength λ1 of the monochromatic light beam F and to a second wavelength λ2 of the exit polychromatic radiation different from the first wavelength λ1, respectively, the invention makes it possible to circumvent errors or variations linked to the sensors themselves (for example variations in the temperature of the sensors). This is all the more pertinent in that the sensors are placed very closely in the lighting module with the result that they are subjected to similar constraints.

It should be noted that the invention should not be reduced to the means and configurations described and shown, but applies equally to all equivalent means or configurations and to any combination of such means. Regardless of the embodiment adopted, a control device of this kind is of particular benefit in the production of a motor vehicle lighting and/or signaling lighting module. In this case, the wavelength conversion element 4 is advantageously placed substantially in a focal plane of a device for forming a light beam F′ from the converted polychromatic radiation, for example a focal plane of a lens 18 as shown in FIG. 1.

According to the embodiment described above and illustrated by FIG. 1, the first sensing means 6, the second sensing means 8 and the monochromatic light source 2 are situated on the same side of the wavelength conversion element 4 and it is the reflected portion of the exit polychromatic radiation that is sent to the first and second sensing means 6 and 8. A reflector or layer of reflective material 20 is then placed behind the wavelength conversion element 4 so that the refracted portion and the reflected portion are on the same side of the wavelength conversion element 4 and so that the maximum converted radiation is directed toward the first and second sensing means 6 and 8.

According to one alternative embodiment of the invention, not represented, the first and second sensing means 6 and 8 and the monochromatic light source 2 may be disposed on opposite sides of the wavelength conversion element 4. The polychromatic radiation is then transmitted through the wavelength conversion element 4, which then does not include the reflector or layer of reflective material 20.

According to another alternative embodiment, as in the embodiment shown, the first and second sensing means 6 and 8 may be disposed on the same side of the wavelength conversion element 4 as the monochromatic light source 2 but also on the same side as the source relative to the optical axis passing through the center of the lens 18 and normal to the reflector or layer of reflective material 20. The first and second sensing means 6 and 8 are thus placed in the vicinity of the monochromatic light source 2 and the converted rays impact on them to produce measurements according to the invention after reflection at a mirror disposed on the opposite side of this optical axis to the sensors and the monochromatic light source 2.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A device for controlling the color of polychromatic light, in which a light beam (F), emitted by a coherent monochromatic source, is directed toward a conversion element adapted to convert said directional monochromatic light beam (F) into undirectional polychromatic light, and which includes at least:
first sensing means sensitive to a first wavelength (λ1) of said light beam emitted by said monochromatic source and adapted to supply a first signal (S1) representing the quantity of light that it has received at said first wavelength (λ1),
second sensing means sensitive to a second wavelength (λ2), different from said first wavelength (λ1) of said light beam (F) emitted by said monochromatic source, and adapted to supply a second signal (S2) representing the quantity of light that it has received at second wavelength (λ2),
calculation means adapted to establish a relation (ρ) between said first signal (S1) and said second signal (S2), and
a control module adapted to generate instructions to said monochromatic source and/or to said conversion element to modify the operation thereof so as to modify said relation (ρ).

2. The device according to claim 1, wherein said control module includes at least comparison means for comparing said relation (ρ) with predefined values to generate a third signal (S3) representing the result of this comparison for the generation of instructions.

3. The device according to claim 2, wherein said control module includes control means adapted to generate said instructions as a function of said third signal (S3) supplied by said comparison means.

4. The device according to claim 2, wherein said predefined values are supplied at an input of said comparison means by set point means including a set of predefined values.

5. The device according to claim 4, wherein said set point means include at least one set point value corresponding to a predefined optimum value of said relation (ρ) established by said calculation means and a maximum value and a minimum value of that same relation that are acceptable.

6. The device according to claim 1, wherein instructions generated by said control module are adapted to control said monochromatic source to modify an emitted power thereof.

7. The device according to claim 1, wherein instructions generated by said control module are adapted to control said conversion element to modify a temperature thereof.

8. The device according to claim 1, wherein said first sensing means and said second sensing means are placed in the vicinity of one another so as to intercept a portion of the undirectional polychromatic radiation converted by said conversion element.

9. The device according to claim 8, wherein said first sensing means and said second sensing means are carried by the same support means (9).

10. The device according to claim 1, wherein said first sensing means and/or said second sensing means include a filter adapted to qualify a wavelength of the rays detected by said first and second sensing means.

11. The device according to claim 10, wherein one of said first or second sensing means include a high-pass filter and the other a low-pass filter.

12. The device according to claim 1, wherein said second wavelength (λ2) to which said second sensing means are sensitive is close to said first wavelength (λ1) of the light emitted by said monochromatic source.

13. The device according to claim 1, wherein said first wavelength (λ1) of the light emitted by said monochromatic source is situated in the blue region of the visible spectrum.

14. The device according to claim 12, wherein said second wavelength (λ2) to which said second sensing means are sensitive is situated in the green region of the visible spectrum.

15. The device according to claim 13, wherein said conversion element contains phosphorescent and/or florescent material.

16. The device according to claim 1, wherein said first and second sensing means are placed on the same side of said conversion element as said monochromatic source.

17. The device according to claim 16, wherein said conversion element includes a reflector element on its face opposite its face receiving said directional monochromatic light beam (F).

18. The device according to claim 17, wherein said first and second sensing means are placed substantially in the specular reflection cone with regard to said conversion element and an angle of incidence of said directional monochromatic light beam (F) on it.

19. The device according to claim 1, wherein said first and second sensing means are placed opposite said monochromatic source with regard to said conversion element.

20. A motor vehicle lighting and/or signaling lighting module, wherein said motor vehicle lighting and/or signaling lighting module includes at least one device according to claim 1 and in that said conversion element of this device is substantially placed in a focal plane of a system for forming a polychromatic lighting and/or signaling light beam (F′) of the vehicle.
